(19) United States
(12) Patent Application Publication
(10) Pub. No.: US 2008/0279475 A1
(43) Pub. Date: Nov. 13, 2008

(54) Method for manipulating pictures via a wheel mouse

(76) Inventors: Ying-Chu Lee, Yunlin County (TW); Kuo-Wei Lee, Yunlin County (TW)

Correspondence Address: BACON & THOMAS, PLLC, 625 SLATERS LANE, FOURTH FLOOR, ALEXANDRIA, VA, 22314-1176, US

(21) Appl. No.: 12/149,426

(22) Filed: May 1, 2008

(30) Foreign Application Priority Data
May 3, 2007 (TW) 096115685

(51) Int. Cl. G06K 9/36

(52) U.S. Cl. 382/276

(57) ABSTRACT

A method for manipulating pictures by rolling a mouse scrolling wheel is disclosed. The manipulations feature smoothness in operation, abundance in functionality, variety on the screen and much fun for the user's sights. Tool icons operated by the wheel mouse execute various functional commands: including a tool icon for adding or reducing pictures in a window, a tool icon for switching to various display layouts of multiple pictures, a tool icon for swapping the positions of the pictures in a window, a tool icon for rotating the pictures in a predefined degree and direction, and a tool icon for replacing the present picture by another one in a different folder. All these tools could possibly be indispensable tools for the image viewer software someday.

### BACKGROUND OF THE INVENTION

1. Field of the Invention

This invention relates to a method of manipulating pictures by rolling scrolling wheel of a mouse input device, more specifically, to one that manipulates the display functions of pictures in a window.

2. Description of the Prior Art

As a picture is displayed on the screen of a graphical user interface, the prior art approach in manipulating the picture is done by clicking the left button of a mouse with the mouse cursor on a tool icon. A drawback of the approach is that one tool icon can be executed only one function. Successive manipulations call for a succession of clicks, which considerably fatigues the user. It could be better to use a mouse scrolling wheel, since the wheel features two directions, that is, capable of executing two functions, and the rolling of the scrolling wheel has been proved to ease the successive manipulations considerably than the keystroke.

If a demand for adding pictures in a window, the conventional way to handle the demand is by means of a button, which consequently fails to provide the user the promptness in switching between a single and multiple pictures. Nevertheless, the use of the scrolling wheel enables the successive adding of pictures, while the successive reducing of pictures can be done quickly by reversing the operation.

To switch among various display layouts of multiple pictures, the prior art manipulation approach is to provide tool icons for the corresponding display layouts for user's clicking. The drawback of this approach is that too many icons occupy too much screen space, and during the transitions among various display layouts, each transition to a display layout calls for one keystroke, which surely deteriorates the overall usage.

To swap the display positions of multiple pictures in a window, the conventional approach is to swap the two pictures by dragging each to its new position. Besides, there is no handy manipulation means provided for swapping the pictures.

To rotate a picture, the conventional approach is by means of the keystroke, and usually offers two icons, one for rotating 90 degrees clockwise while the other 90 degrees counterclockwise. However, a single tool icon is enough to accomplish the same function by the scrolling wheel.

When rolling the scrolling wheel of a mouse to transit the present picture into a previous or a next picture, the conventional approach can only handle the switching of the pictures in the same folder. Currently, the switching of pictures in different folders is not possible to carry out only by way of rolling the scrolling wheel of a mouse.

### SUMMARY OF THE INVENTION

The present invention offers multiple tools manipulated by the mouse wheel. The manipulation approach is as follows:

Moving the mouse cursor onto a tool icon and rolling the mouse scrolling wheel, will execute the command associated with the tool icon. On the contrary, the command will not be executed if the mouse cursor is not on the tool icon when rolling the mouse wheel.

Once the cursor is being placed onto a tool icon, the offered multiple tools can provide three manipulation functions: scrolling up, scrolling down, and clicking the left button of the mouse. It not only substantially decreases the numbers of the tool icons and simplifies the user interface, but further smoothes the operation.

The present invention offers a tool icon on which mouse cursor is put, where pictures can be added in the window by rolling the mouse scrolling wheel down, while pictures can be reduced from the window by rolling the mouse scrolling wheel up.

For those pictures having already been seen, it's not too much fun for browsing one picture per time. Occasionally, a browse of multiple pictures is interesting and fun. The present invention is capable of satisfying the desire of prompt switching between a present single and multiple pictures during browsing.

The invention offers a tool icon, where various display layouts of the multiple pictures in a window can be switched just by rolling the mouse scrolling wheel, provided that the mouse cursor is placed on the tool icon.

The invention approach can switch among all the display layouts by utilizing only a single icon, where the prompt layout transition facilitates an abundance of sight, and also helps the user spot a satisfied layout in a minute.

The invention offers a tool icon, where each individual picture of a display layout can be switched its position with another one by rolling the mouse scrolling wheel with the cursor on the icon.

When there are multiple pictures in a window, the positions of the pictures can be swapped by way of dragging, where the user first has to place the mouse cursor on the picture to be swapped, followed by dragging the picture to the target position, and then swapping both positions. However, the present invention features a prompt swapping of the positions of pictures without the need to move mouse cursor by the user.

The invention offers a tool icon, where a picture can be rotated 90 degrees clockwise or counterclockwise by rolling the mouse scrolling wheel with the cursor on the icon. When pressing the Alt key at the keyboard and simultaneously rolling the mouse scrolling wheel, a picture can be rotated 15 degrees clockwise or counterclockwise. A picture can be flipped over horizontally by clicking the left button of the mouse with respect to the same icon. Therefore, a single tool icon is enough for a picture to be manipulated into doing all kinds of rotations and flips. The invention offers a tool icon, where switching of pictures in different folders can be accomplished by rolling the mouse scrolling wheel with the cursor on the tool icon.

Compared with the prior art, the mouse wheel can only be used to switch pictures in the same folder, whereas the present invention enables the user to switch the present picture with another one in a different folder simply by rolling the mouse scrolling wheel with the cursor on the tool icon. By rolling the scrolling wheel up will replace the present picture with the first picture in the preceding folder relative to the present picture, while rolling the scrolling wheel down will replace the present picture with the first picture of the next folder relative to the present picture. Accordingly, it allows the user promptly to switch to a different folder. The five wheel-based tools offered by the present invention not only feature great smoothness in the manipulation and lively views in the successive manipulations but boost lots of browsing delights for the user.

### BRIEF DESCRIPTION OF THE DRAWINGS

FIG. 1 exhibits mouse wheel-based tools;

FIG. 2 is an operational schematic diagram (I.) showing the adding of pictures in a window by a mouse wheel;

FIG. 3 is an operational schematic diagram (II.) showing the adding of pictures in a window by a mouse button;

FIG. 4 is an operational schematic diagram (I.) showing various display layouts of the screen switched by rolling the scrolling wheel;

FIG. 5 is an operational schematic diagram (II.) showing various display layouts of the screen switched by rolling the scrolling wheel;

FIG. 6 is an operational schematic diagram showing the pressing of the left button to enlarge or contract pictures altogether when rolling the scrolling wheel to switch various display layouts;

FIG. 7A is an operational schematic diagram (I.) showing the switching of the positions of pictures;

FIG. 7B is an operational schematic diagram (II.) showing the switching of the positions of pictures; and

FIG. 8 is a schematic diagram showing the variations of the screen by a succession of manipulations on the various wheel-based tools.

### DETAILED DESCRIPTION OF THE INVENTION

An exemplified embodiment of the present invention is ShowGraph software.

A detailed description with accompanying drawing is as follows:

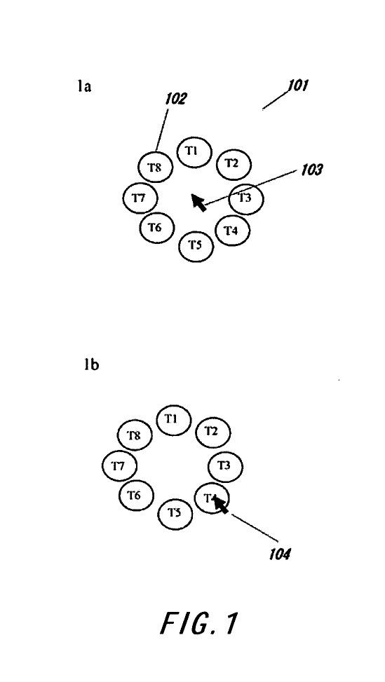

The software is provided with a circular operational interface, with eight tool icons (T1-T8) locating around a cursor, where each tool icon is formed into a round area (102) with a 32-pixel diameter, named ToolBall (101) in FIG. 1a.

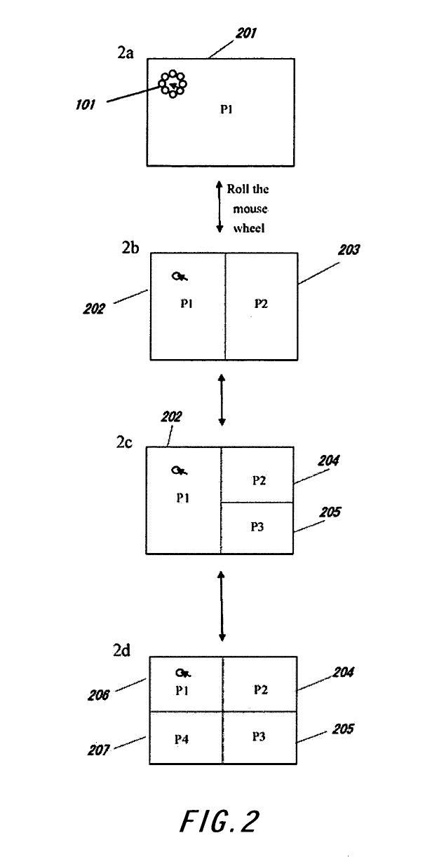

As a picture P1 is shown in a window and a cursor appears there too, the ToolBall can be invoked by pressing the right button of the mouse, and the eight tool icons will then be presented around the cursor as shown in FIG. 2a.

At this moment the rectangular display frame 201 of the picture P1 equals to the whole display layout.

If the picture P1 is larger in size than the rectangular display frame 201, the portion goes beyond the frame will not be displayed. On the other hand, if the picture P1 is smaller than the frame, the portion short will present background color.

The software can load up to four pictures altogether as shown in FIG. 2d.

### <Adding or Reducing Pictures in a Window>

Place the cursor onto the icon T4 (104) shown in FIG. 1b.

### [To Roll Mouse Scrolling Wheel Down to Add Pictures in a Window]

By rolling a mouse scrolling wheel down, the next picture (Picture P2) with respect to the present picture P1 will be fetched to open from the folder that holds the picture P1, followed by displaying the two pictures P1, P2 together in the window shown in FIG. 2b.

At the time being the rectangular display frame 202 of the picture P1 is located in the left half of the display layout, while the rectangular display frame 203 of the picture P2 is located in the right half of the display layout. Each occupies half of the display layout.

As the scrolling wheel is being kept on rolling, the next picture (Picture P3) with respect to the picture P2 will be fetched to open from the folder that holds the picture P2, followed by displaying the three pictures P1, P2, and P3 together in the window shown in FIG. 2c.

At this time the rectangular display frame 204 of the picture P2 is contracted into one fourth of the display layout and located on the top right corner. One fourth of the display layout on the bottom right corner is used for accommodating the rectangular display frame 205 of the picture P3.

As the scrolling wheel is again being kept on rolling, the next picture (Picture P4) with respect to the picture P3 will be fetched to open from the folder that holds the picture P3, followed by displaying the four pictures P1, P2, P3, and P4 together in the window shown in FIG. 2d.

The rectangular display frame 206 of the picture P1 is then contracted into one fourth of the display layout and located on the top left corner. One fourth of the display layout on the bottom left corner is used for accommodating the rectangular display frame 207 of the picture P4.

During rolling the scrolling wheel to add pictures, the predetermined rule for adding a new picture—adding the picture which is the next to the last present picture.

### [To Roll Mouse Scrolling Wheel Up to Reduce Pictures in a Window]

Place the mouse cursor onto the same tool icon T4. By reversely rolling the mouse scrolling wheel (rolling up), one picture is reduced each time, and the sequence will be dropping off from three pictures (shown in FIG. 2c), through two pictures (shown in FIG. 2b), to one picture (shown in FIG. 2a).

### [To Press Mouse Button to Add Pictures in a Window]

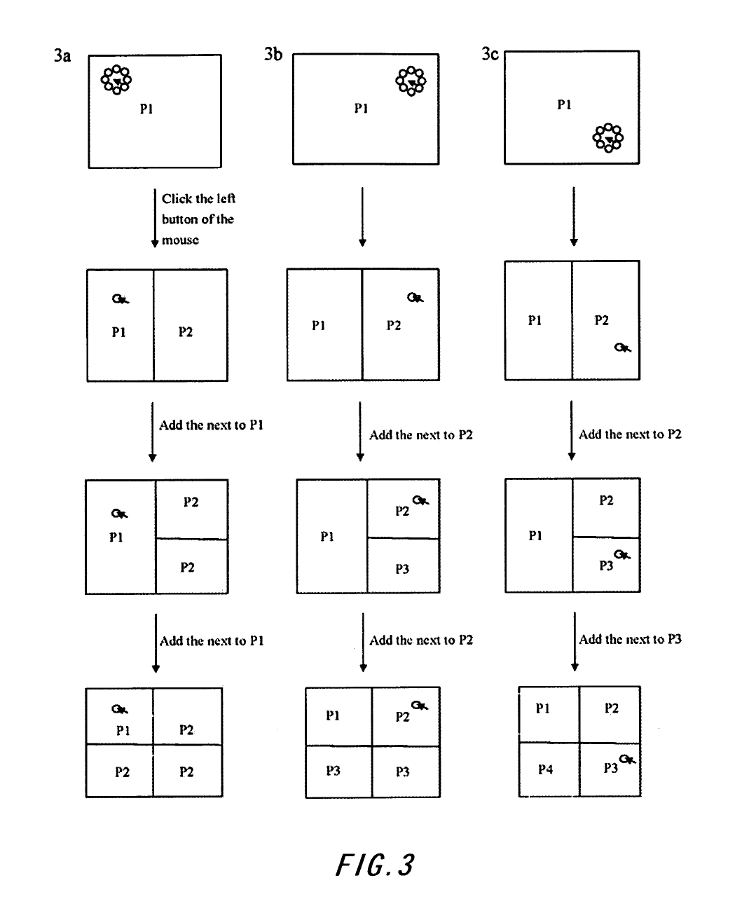

Place the mouse cursor on the tool icon T4 as usual, and the adding of a picture can also be executed by clicking the left button of the mouse. The difference compared with the rolling of the mouse scrolling wheel is that the newly added picture is the next to the picture on which the ToolBall is located (FIGS. 3a-3c); instead of the next to the last present picture (FIGS. 2b-2d). Therefore, when the left button of the mouse is used to add pictures, the user has to watch out the location on which the ToolBall resides, since the different location of the ToolBall means that the different picture will be added.

To switch off the ToolBall—to let it disappear, the feature of rolling the mouse scrolling wheel turns into invoking the previous picture or the next picture.

Therefore, once a user is not satisfied with the newly added picture, he could place the mouse cursor on the picture and roll the scrolling wheel to replace it with its previous or next picture. A successive rolling will replace the present picture with each of the pictures in the folder.

As the ShowGraph software is invoking the previous or next picture by rolling the mouse scrolling wheel, a judgment will be made first to spot which display layout the cursor is located on (FIGS. 2a-2d are four different display layouts), and which rectangular display frame the cursor is located on (201-207 are seven different rectangular display frames), then followed by processing the replacement of the picture.

<Changing into Different Display Layout>

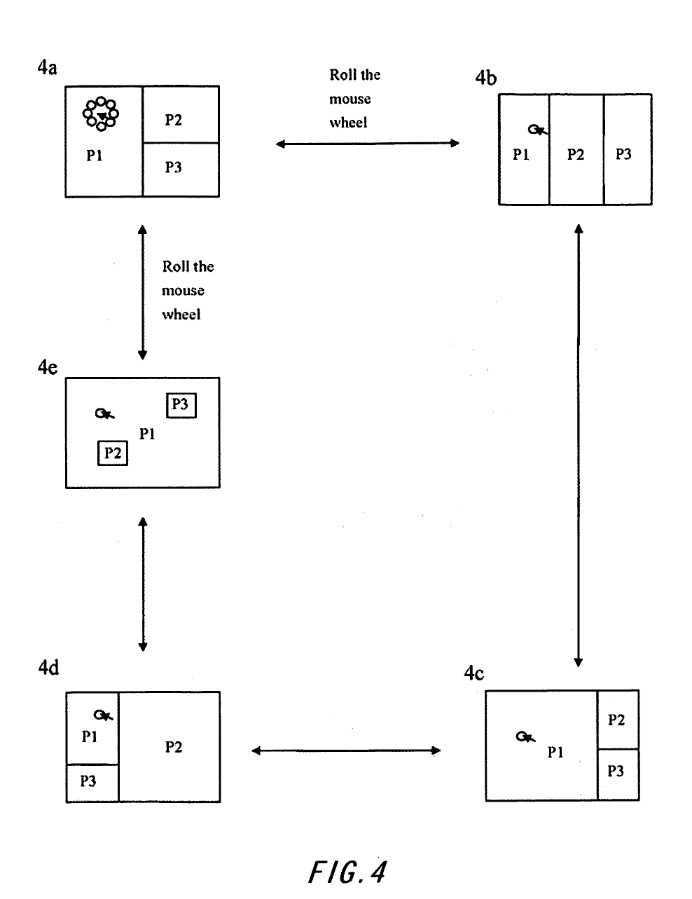

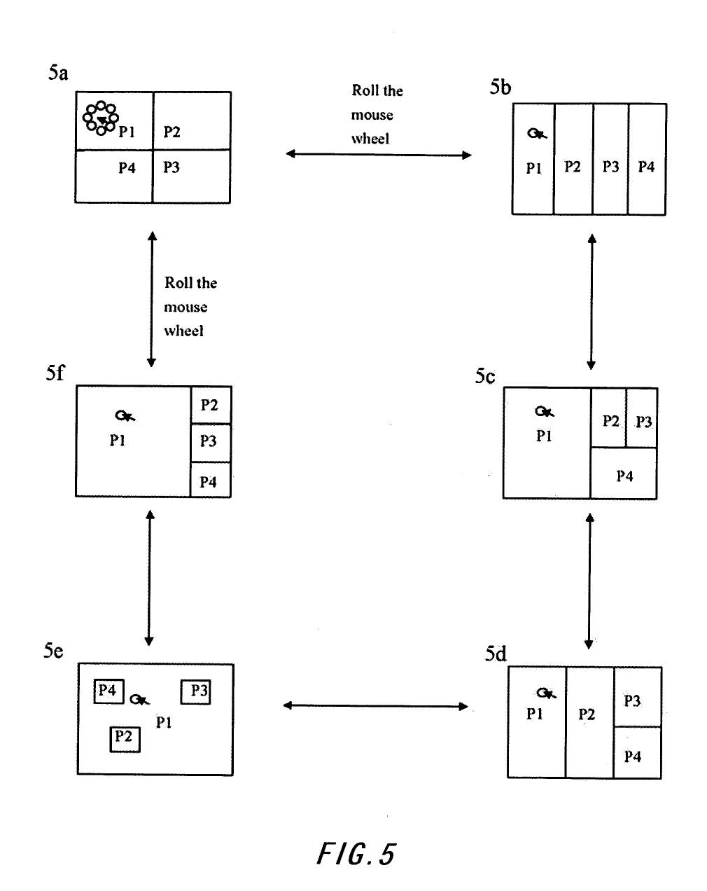

The ShowGraph software offers five display layouts (FIGS. 4a-4e) for three pictures in a window, while offering six display layouts (FIGS. 5a-5f) for four pictures in the window. The software also offers a tool icon (FIG. 1a.T5). Once placing the cursor onto the icon and rolling the mouse scrolling wheel, the five display layouts (FIGS. 4a-4e) can be switched in order for the three pictures, and the six display layouts (FIGS. 5a-5f) can be switched in order for the four pictures. In the display layouts 4e and 5e, the rectangular display frame of the picture P1 accommodates the rectangular display frames of the rest of the pictures. Aside from the two display layouts 4e, 5e, the rectangular display frames of the other display layouts won't overlap one another.

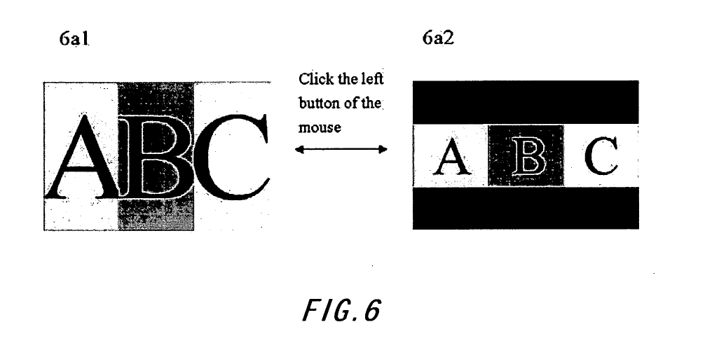

Place the mouse cursor onto the icon T5 as usual, and click the left button of the mouse at the same position, the pictures in a display layout will be enlarged or contracted altogether (shown in FIGS. 6a1 & 6a2).

Referring to 6a1, as the picture is enlarged to fill the entire space of the rectangular display frame, the portion of the picture that is visible is only the middle part.

Referring to 6a2, as the picture is contracted to the extent to see its whole, which occupies only a portion of the rectangular display frame, and the rest is filled with background color.

Either the 6a1 or the 6a2 has its own merit and drawback; therefore, prompt switching between them is deadly demanded.

### <Switching the Positions of Pictures>

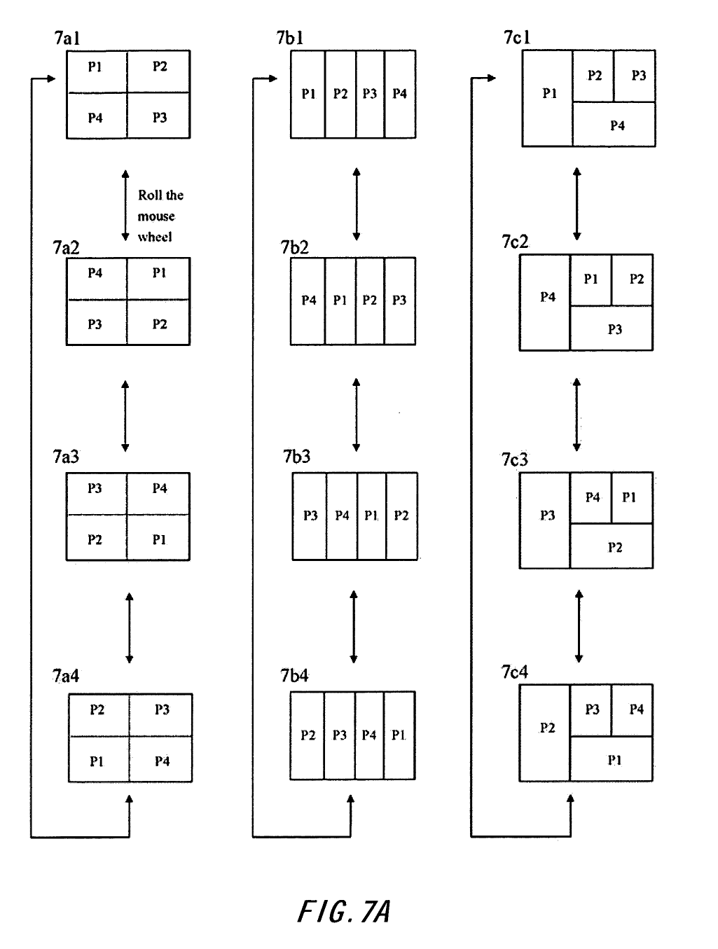

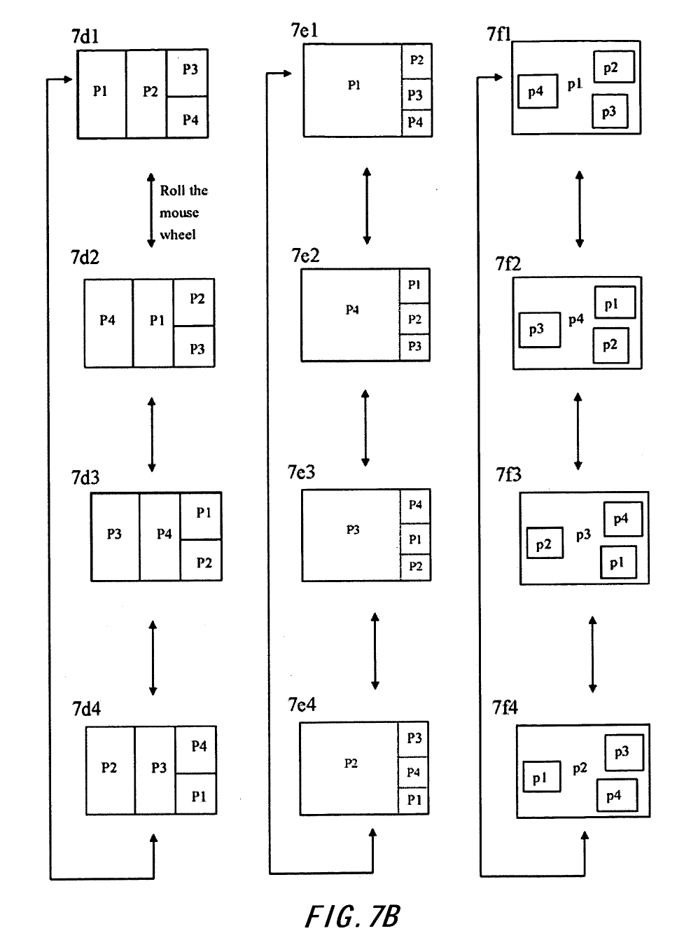

The ShowGraph software offers a tool icon (FIG. 1a.T6). Placing the cursor onto the tool icon and rolling the mouse scrolling wheel, every picture in a display layout can be switched for its position in order shown in FIGS. 7a1-7f4.

During the switching positions, every rectangular display frame in the display layout won't change, but pictures are moving their positions within each rectangular display frame. Once a picture is locating in a new rectangular frame, the picture has to be enlarged or contracted subject to the size of the new rectangular frame.

### <Rotating Pictures>

The ShowGraph software offers a tool icon (FIG. 1a.T8). Place the mouse cursor onto the tool icon and roll the mouse scrolling wheel up, the picture will rotate 90 degrees counterclockwise; on the contrary, by rolling the mouse scrolling wheel down, the picture will rotate 90 degrees clockwise. When pressing the key Alt at the keyboard, followed by rolling on the mouse scrolling wheel, the picture will engage a 15-degree rotation clockwise or counterclockwise. Once clicking the left button of the mouse with respect to the same tool icon, the picture will engage a horizontal flip.

<Changing a Picture into Another One in a Different Folder>

The ShowGraph software offers a tool icon (FIG. 1a.T1). Place the mouse cursor onto the tool icon and roll the mouse scrolling wheel, the picture on which the ToolBall center is located can be replaced by a picture in a different folder.

The ShowGraph software arranges multiple folders containing pictures in order.

Once a present picture requires to be replaced with a new picture in a different folder, the new one is formulated to be the first picture of the next or previous folder with respect to the folder in which the present picture resides.

The present picture can be also replaced with a new one in a different folder without using the aforesaid tool. The approach is as follows:

Under the case that the ToolBall is not displaying, move the cursor on a picture, press the ctrl key at the keyboard, and roll the mouse scrolling wheel, the present picture can then be replaced with the first picture of its next or previous folder.

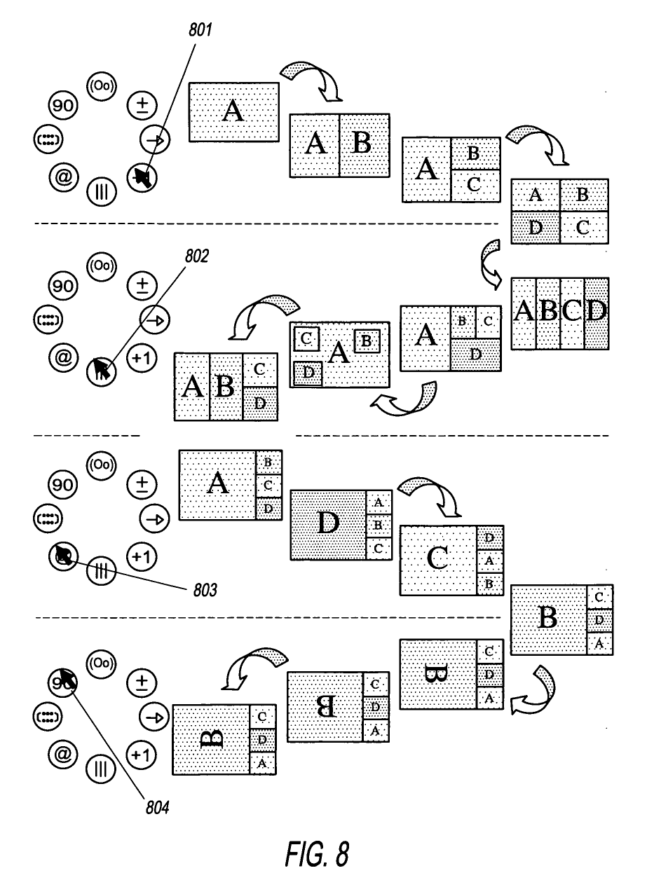

The ShowGraph software places the four tools: adding pictures, layout switching, picture swapping, and picture rotating together (FIG. 1. T4, T5, T6, T8). It shows (FIG. 8) from displaying picture A, through adding picture B, picture C, and picture D.

Next, it is changing into different display layouts for the pictures A, B, C, and D. Then, it is switching the positions of the four pictures A, B, C, and D.

And the picture B is made into multiple 90-degree rotations.

The series of manipulations can be accomplished in a minute only by moving the cursor within the four tool icons and by rolling the scrolling wheel.

What is claimed is:

1. A method for manipulating pictures via a mouse wheel, where a window has been activated to display N pieces (N>0) of pictures, offering a tool icon which features a functional command to add pictures, and once the mouse cursor being placed onto the icon followed by rolling the mouse wheel, a picture then being added to the window.

2. A method for manipulating pictures via a mouse wheel as in claim 1, wherein a picture is added to the window by rolling the mouse wheel forward, while a pictures is reduced from the window by rolling the mouse wheel backward.

3. A method for manipulating pictures via a mouse wheel, where a window has been activated to display a plurality of pictures, offering a tool icon which features a functional command to switch among different display layouts having a plurality of pictures, and once the mouse cursor being placed onto the icon followed by rolling the mouse wheel, the different display layouts of a plurality of pictures are then being switched.

4. A method for manipulating pictures via a mouse wheel as in claim 3, wherein the left button of the mouse is being clicked with the cursor placed on the same tool icon, the pictures thereon being enlarged or contracted altogether.

5. A method for manipulating pictures via a mouse wheel, where N pieces (N>1) of pictures have been displayed in a window, offering a tool icon which features a functional command to switch positions for pictures, and once the mouse cursor being placed on the icon followed by rolling the mouse wheel, positions of N pieces of the pictures then being switched.

6. A method for manipulating pictures via a mouse wheel, where pictures have been displayed in a window, offering a tool icon which features a functional command to rotate a picture, and once the mouse cursor being placed on the icon followed by rolling the mouse wheel, the picture in the window then being activated to rotate a predefined degree clockwise or counterclockwise.

7. A method for manipulating pictures via a mouse wheel as in claim 6, wherein the left button of the mouse is being clicked with the cursor placed on the same tool icon, the pictures thereon being flipped horizontally.

8. A method for manipulating pictures via a mouse wheel, where a plurality of folders containing pictures are arranged in sequence, offering a tool icon which features a functional command to display a picture in a different folder, and once the mouse cursor being placed on the icon followed by rolling the mouse wheel, the present picture in the window then being replaced with a picture in a different folder within the sequence.

9. A method for manipulating pictures via a mouse wheel as in claim 8, wherein the present picture is replaced with a new one in a different folder, the new one being formulated to be the first picture of the next or previous folder with respect to the folder in which the present picture resides.
